(19) United States
(12) Patent Application Publication
(10) Pub. No.: US 2014/0354053 A1
(43) Pub. Date: Dec. 4, 2014

(54) Hybrid wind power generator and concentrator with solar panel for improved power generation

(71) Applicant: Johnny Ramirez, San Diego, CA (US)

(72) Inventor: Johnny Ramirez, San Diego, CA (US)

(21) Appl. No.: 13/999,748

(22) Filed: Mar. 18, 2014

Related U.S. Application Data
(60) Provisional application No. 61/852,115, filed on Mar. 15, 2013.

(51) Int. Cl. F03D 1/04; H02J 4/00; F03D 9/00

(52) U.S. Cl. CPC F03D 1/04; F03D 9/002; H02J 4/00
USPC 307/43; 290/55; 415/222

(57) ABSTRACT

This alternative hybrid wind concentrator generator (the “device”) provides low wind environments with improved added capabilities for various power generation applications. A hybrid solar power system such a solar panel is incorporated on top of the device adding power assistance in low wind conditions and or added power generation. Incorporating in a 2 part housing is a tapering inner shroud that concentrates wind inward then down or up depending on placement. Other added benefits included are the outer housings ability to incorporate added batteries and or electronics for improved multi-function and or plug in functionality. Protection from elements birds, trash, etc. is a key ramification that can help expedite wind permitting procedures as well as improve current laws and restrictions. This alternative wind concentrator device provides discreet placement in urban settings houses, retail buildings, and or office buildings. Another unique benefit is the ability to stack wind device units onto one another via a pole or other support structure for added wind concentration abilities. Ease of mobility is built in due to the products compact compartmentalized characteristics. This can in turn lend it to varying sizes and proportions depending on various product applications.

### BACKGROUND OF THE INVENTION

The present invention is in the technical field of wind generators. More particularly, the present invention is in the technical field of enclosed wind generators. More particularly the present invention is in the technical field of compact enclosed hybrid solar wind power concentrator generators.

In some aspects, the device described herein is a hybrid wind power concentrator that provides alternative wind abilities not normally associated with wind power. The problems associated with small wind power generation are exemplified in urban settings were buildings wind turbulence and permitting issues make most wind power generation products prohibitive or at best lacking in performance. Current laws and permitting restrictions also hold small wind power generation products back. The device described herein seeks to solve these problems as well as provide users alternative capabilities for both stationary and mobile power generation applications. In some aspects, the device provides added power assistance with solar modules incorporated on top of the device. This power is meant for either low wind assist in starting up or contributing power generation.

The hybrid solar concentrator described in some embodiments herein also provides protection from birds, and or elements which hold many wind permits back via impact studies. In some preferred embodiments, the device comprises housing with a horizontal inlet that leads wind into an interior shroud housing that tapers to concentrate wind currents to a central generator blade location. The other way in which the device can provide improved energy generation is through the ability to stack multi units on top of one another via pole or other stacking support structure. With the added housing other abilities to incorporate batteries, electronics, sensors and or other components added value are contemplated herein. Other alternative abilities are made convenient through the compact compartmentalized features that lend its self to travel or mobile setup capabilities.

### BRIEF SUMMARY OF THE INVENTION

Disclosed herein is a hybrid solar wind concentrator (sometimes referred to as the “device”). The device is configured to be used in small wind urban and rural scenarios but may be used in other locations as well. Mounted on buildings, vehicles or poles meant for either stationary and or mobile applications. In some aspects, the device is an alternative wind energy product meant to evolve and improve people's interface with wind energy via flexibility. Added performance characteristics include but are not limited to Solar Hybrid, Wind Concentration, Pole Stack ability, Portability, Easier Permitting and improved capability through overall housing.

### BRIEF DESCRIPTION OF THE DRAWINGS

FIG. 1 is shows a perspective top front view of one example of a device as described herein.

FIG. 2 illustrates a perspective rear bottom view of one example of a device as described herein.

FIG. 3 presents a front view of one example of a device as described herein.

FIG. 4 presents a rear view of one example of a device as described herein.

FIG. 5 presents a bottom view of one example of a device as described herein.

FIG. 6 presents the left side view of one example of a device as described herein.

FIG. 7 presents the right side view of one example of a device as described herein.

FIG. 8 presents the top view of one example of a device as described herein.

FIG. 9 shows an example of a top front exploded view of one example of a device as described herein.

FIG. 10 shows an example of top rear exploded view of one example of a device as described herein.

FIG. 11 shows one example of a front top of shroud housing.

FIG. 12 shows one example of a top rear of shroud housing with rear and front mount details.

FIG. 13 illustrates an example of a rear bottom of shroud with front and rear mount details.

### DETAILED DESCRIPTION AND BEST MODE OF IMPLEMENTATION

Some embodiments of the present invention are illustrated as an example and are not limited by the figures of the accompanying drawings, in which like references may indicate similar elements and in which the device may comprise:

1) Solar panel

2) Ruder

3) Top housing

4) Bottom housing

5) Intake ring

6) Intake screen

7) Rear louvers

8) Bottom louvers

9) Rear panel

10) Shroud housing

11) Shroud front mount

12) Shroud rear mount

13) Wind blades

14) Electric generator

15) Generator mount

16) Top frame

17) Bottom frame

18) Rear frame

19) Bottom frame rail

20) Top skin

21) Bottom skin

22) Generator cover

23) Shroud rear opening

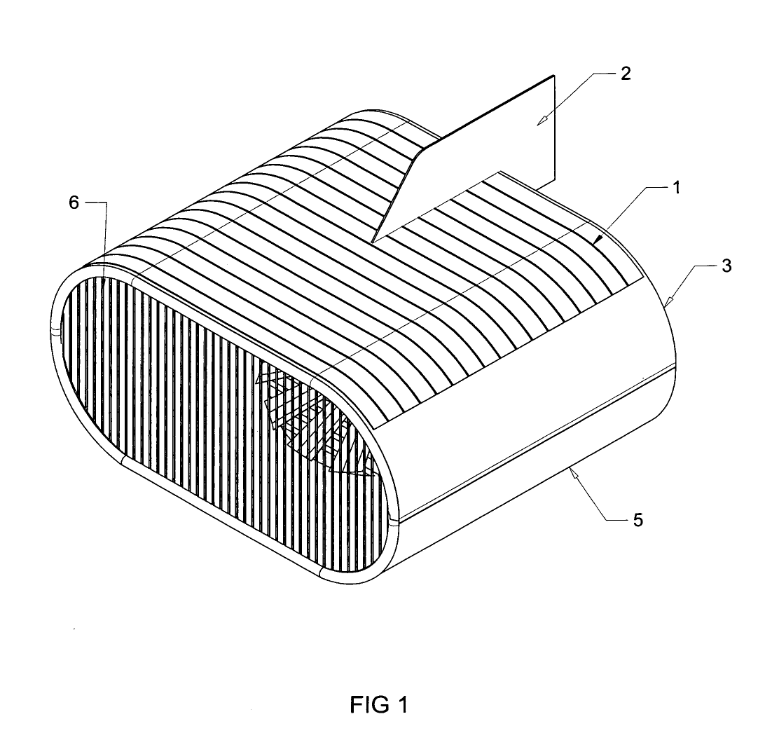

FIG. 1 shows a perspective of one example of a Hybrid Wind Concentrator. The pole mounting brackets for a single unit or multiple unit application are not represented in any of the FIG examples 1 through 13 but are contemplated herein. The outer housing is assembled with aluminum sheeting skins applied to bottom frame 17 top frame 16 and rear frame 18.

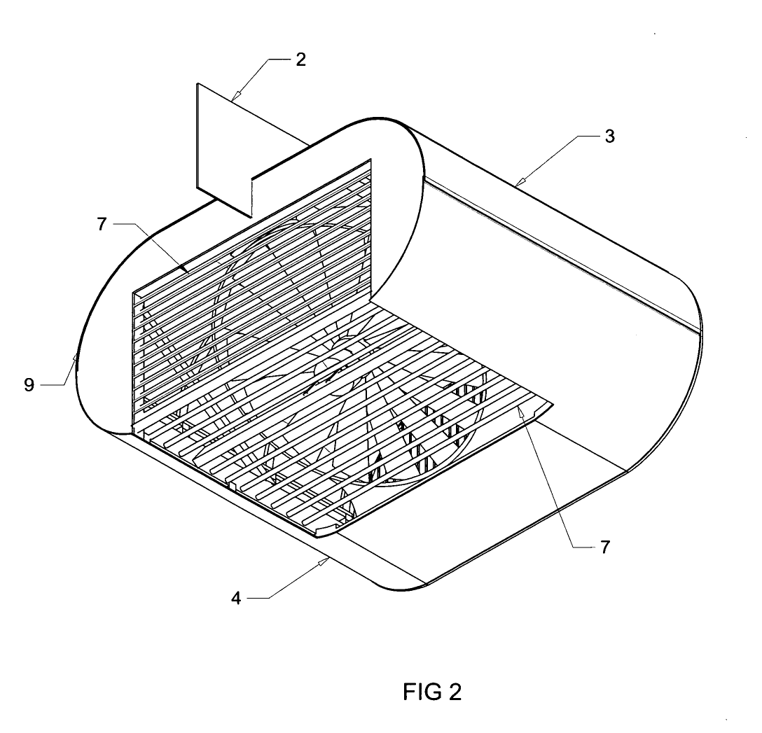

FIG. 2 presents the bottom louvers 8 and the rear louvers 7 meant for emitting air flow down and back. The louvers are designed to be made from a composite plastic or aluminum flat bar but may be made from other suitable materials as well.

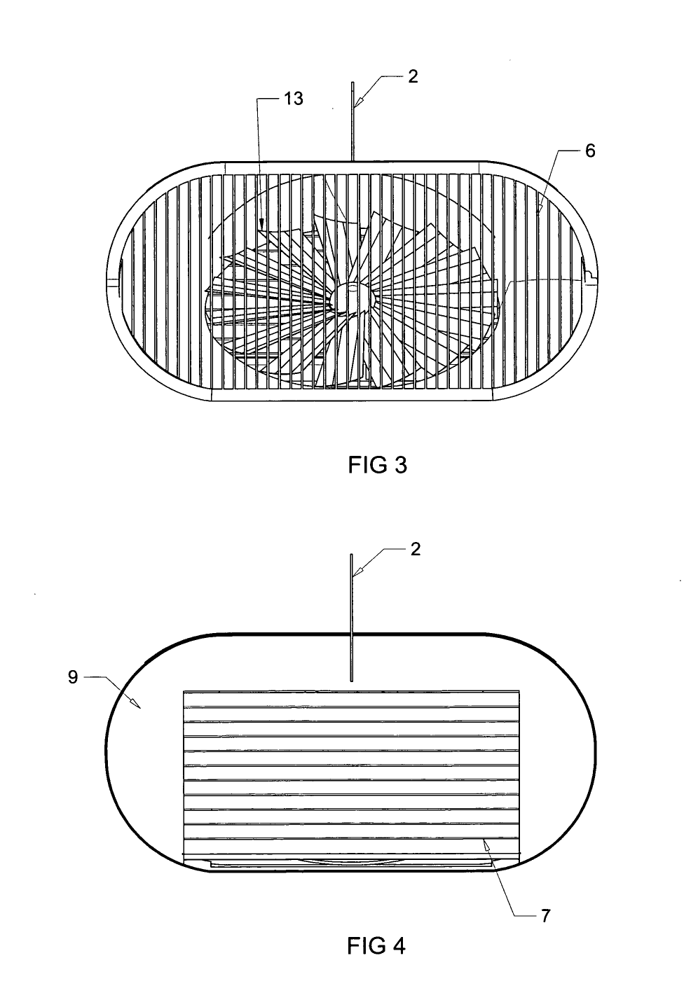

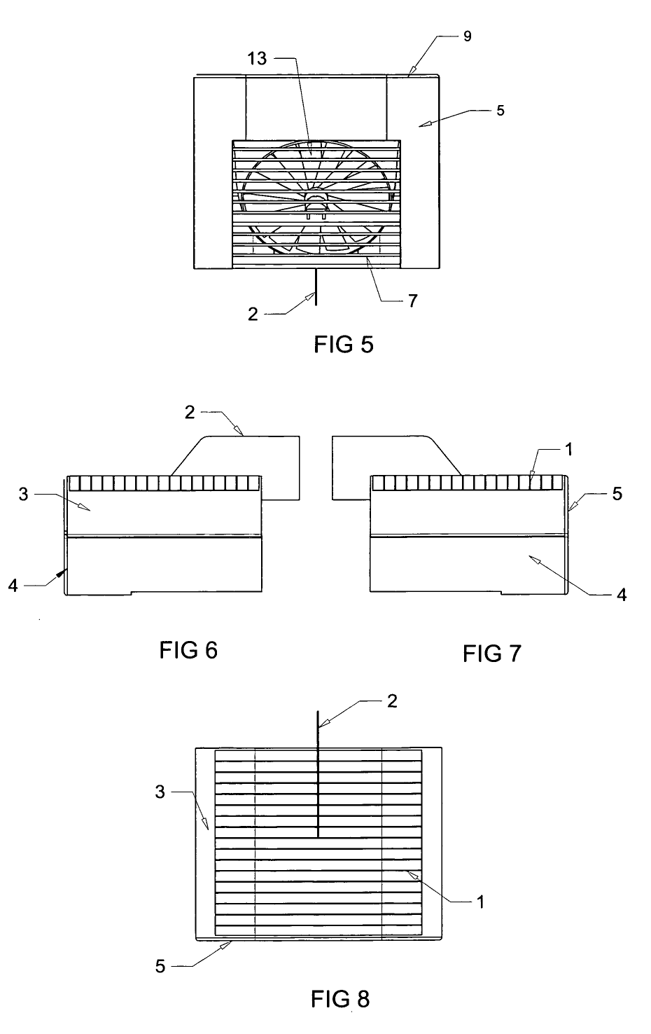

FIG. 3 shows the front view with the outer intake ring 5 and the intake screen 6 made from round small diameter rods. The intake ring 5 is a custom formed half round part made from plastic or composite material but may be made from other suitable materials as well.

FIG. 4 is an example of the rear with rear louvers presented in the down and out angle to repel moisture.

FIGS. 5,6 7 and 8 represent the top bottom and sides of an example of the device. The solar panel located at the top of the device is meant to be flexible with a protective coating.

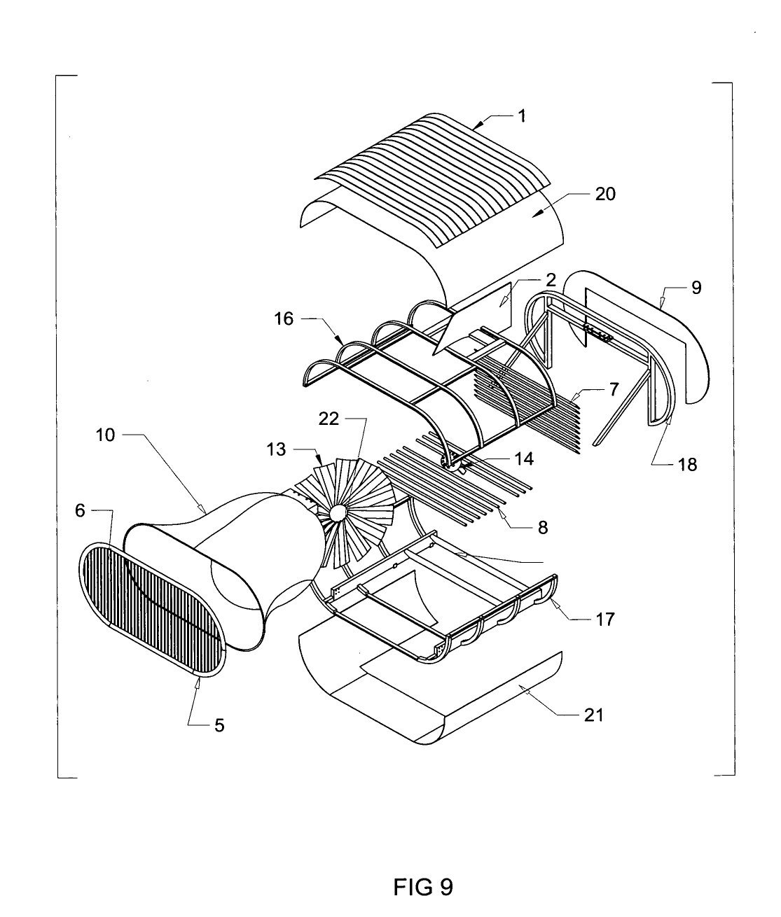

FIG. 9 is an exploded view showing aluminum frames, top frame 16, bottom frame 17, rear frame 18 shroud housing 10 respective outer panels and all parts that go to comprise the hybrid solar wind concentrator device described in various embodiments herein.

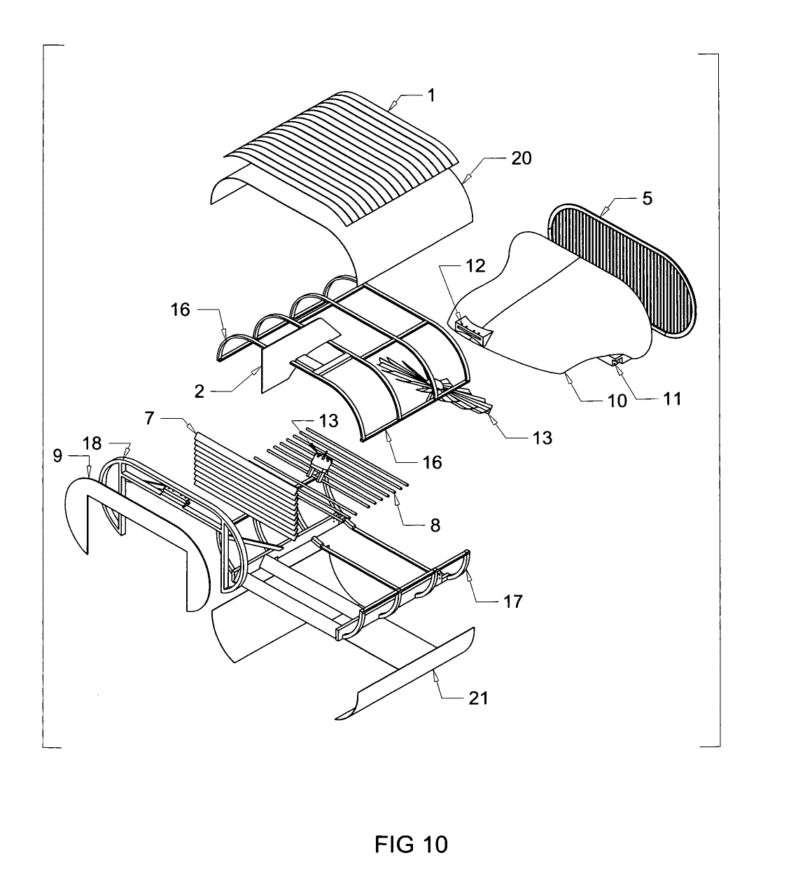

FIG. 10 is an opposite exploded view showing various components of the device according to some embodiments.

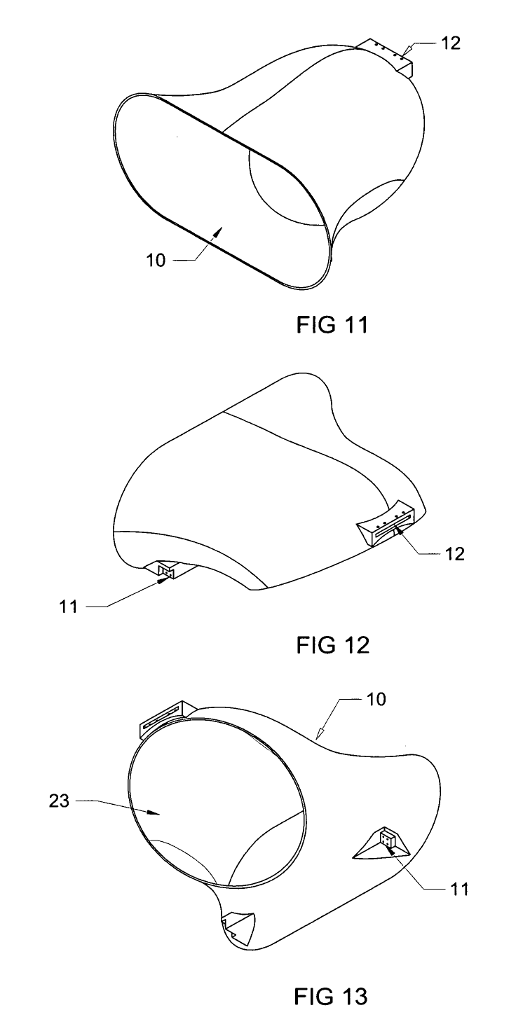

FIGS. 11 through 13 present the shroud front mounts 11 and rear mount 12. The shroud is meant to channel and concentrate the wind. It may be monolithic formed with a top and bottom that will be fused together or from a mold that that will allow the part to be made as one piece. FIG. 11 shows a non-limiting example of the tapering wind inlet component of the device.

In some embodiments the device comprises a plurality of power generation medias, such as a solar panel system 1 mounted on top of an outer housing 3 to assist the power generation in low wind currents and or battery and power generation for hybrid assist capabilities providing alternative hybrid embodiments of wind power generating capabilities. The device may further comprise capabilities for added batteries components and or electronics.

In some preferred embodiments, the device comprises a novel tapering wind inlet design such as a shroud housing 10 which may be made from various sizes and materials. The device further incorporating an outer an inner housing that tapers wind currents inward towards a central alternator with blades to convey the concentrated wind currents converted into improved power, concentrated wind power generation via enclosed compact housing and shroud.

In some embodiments, the device is a wind powered generator that provides improved discreet power production and is protected from the elements or other natural hazards. The device comprising an outer and inner housings enclosure for a power generator wherein said generator is configured to convert natural wind energy from a blade 13, solar panel 1, and/or batteries (optional) to power electronic or other devices.

I claim:

1. A compact wind concentrator hybrid device which may be mounted on poles, buildings, and used for mobile power generation applications comprising a tapering wind inlet of various horizontal proportions and sizes.

2. The device of claim 1 further comprising a plurality of power generation components including a solar panel system on top of an outer housing to assist in low wind currents and or battery and power generation for hybrid assist capabilities providing alternative hybrid embodiments of wind power generating capabilities, also comprising of capabilities for added batteries components and or electronics.

3. The device of claim 1 wherein a plurality of compact low profile wind power generator devices with substantially horizontal housings may be stacked onto each other thereby forming a plurality of wind generator devices with their housings stacked via pole or other structure capable of discreet protected wind power generators in conjunction with buildings vehicles and or poles.

4. The device of claim 1 further comprising a wind tapering inlet which may be made from various sizes and materials and also incorporating an outer an inner housing that tapers wind currents inward towards a central alternator with blades to convey the concentrated wind currents converted into improved power, concentrated wind power generation via enclosed compact housing and shroud.

5. The device of claim 1 wherein the device acts as a wind generator that provides improved discreet power production and is protected from the elements or other natural hazards comprising an outer and inner housings enclosure for a power generator, and added batteries, components and or electronics with a solar panel on top for improved power generations in low wind conditions.
